(19) United States
(12) Patent Application Publication
(10) Pub. No.: US 2018/0247170 A1
(43) Pub. Date: Aug. 30, 2018

(54) AUTHENTICATION AND ANTI-HARVESTING SECURITY FEATURE WITH MACHINE DETECTABLE INDICIA

(71) Applicant: Crane & Co., Inc., Boston, MA (US)

(72) Inventor: Eric M Ziegler, Lexington, MA (US)

(73) Assignee: Crane & Co., Inc., Boston, MA (US)

(21) Appl. No.: 15/894,750

(22) Filed: Feb. 12, 2018

Related U.S. Application Data
(60) Provisional application No. 62/457,230, filed on Feb. 10, 2017.

(51) Int. Cl. G06K 19/06

(52) U.S. Cl. CPC G06K 19/06046; G06K 19/06037

(57) ABSTRACT

A security feature, which is made up of a security device that is coupled to machine detectable indicia, is provided. The security feature may be used with a banknote, with the security feature serving to authenticate the banknote. Harvesting the security device will disturb the machine readable effect or signal generated by the machine detectable indicia, thereby allowing detection of the harvesting.

### RELATED APPLICATION

This application claims priority to U.S. Provisional Patent Application Ser. No. 62/457,230, filed Feb. 10, 2017, which is incorporated herein in its entirety by reference.

### TECHNICAL FIELD

The present invention generally relates to a security feature for incorporation on/in high value or high security products for purposes of authenticating or aestheticizing said products. Particularly, the instant invention relates to a security feature which comprises a security device coupled to machine detectable indicia.

### BACKGROUND

Security devices are often employed in industries of high value or high security products to impart authenticity or aesthetics to such products. Consumer and end-user affinity for such products and their confidence in the source and authenticity of such products often rely on the presence of these security devices. Correspondingly, manufacturers and distributors of such high value or high security products rely on the high manufacturing costs, sophistication and complexity of these security devices to deter would-be counterfeiters from attempting to produce counterfeit products.

For example, manufacturers often affix security devices to high value products such as consumer products including, expensive clothing, personal care products, or utility products. Similarly, manufacturers often affix security devices to high security products such as banknotes, checks, stamps, certificates, identification documents, passports and national security machine components.

Examples of such security devices often take the form of threads, patches, stripes or foils. Each of these forms can be manufactured to provide any combination of holographic, micro-optic, micro-text, optical variability or machine readable effects, for example. These security devices all require a certain level of cost, sophistication and complexity to manufacture which can be prohibitive to a would-be counterfeiter. The optical variability, micro-text and machine readable effects of many of these devices are quite adept at deterring many would-be counterfeiters who would ordinarily rely on sophisticated printing technologies to produce counterfeit products. Nonetheless, such devices are still susceptible to other less ubiquitous tools and processes that are available to counterfeiters. For example, harvesting still remains one of the major means available to counterfeiters for producing quality counterfeits that defeat/pass consumer examination. Harvesting as understood by a person having ordinary skill in the art (PHOSITA) includes the tampering with a security device or removal of a security device or portions thereof from one authentic product and affixing at least portions of the security device to another counterfeit product. One form of harvesting is, for example, banknote harvesting which includes removing a portion of a security device from one authentic banknote and affixing the removed portions to a counterfeit banknote of equal value/denomination; thereby creating two banknotes from one. Alternatively, in consumer harvesting a counterfeiter may remove a security device from an inexpensive consumer product and affix it to a much more expensive consumer product that would normally have a similar security device. Such tactics are quite convincing since they generally pass most or all of the examination criteria of a consumer since they will generally produce all of the effects a consumer would expect to find in authentic security devices. This is also quite effective in the banknote industry as well where central banks and other institutions rely on bank equipment machines (BEMs) to detect the presence or absence of certain covert effects incorporated into such security devices. For example, certain central banks and other institutions sometimes rely on the presence a security device that can produce an ultraviolet (UV), infrared (IR) or magnetic signal that is detectable by selected BEMs. Where such machine detectable features are incorporated into layers of a security device, harvesting of the security device can also defeat the examination of the BEMs by harvesting the machine readable security device from one note and affixing it to a counterfeit that will then be read by the BEMs as a real note.

The suitability of security devices as anti-counterfeiting devices also depends on the thickness profile of the security device. Historically, PHOSITAs have encountered various degrees of difficulty when trying to meet this suitability. Often it has been found difficult to add a machine readable component to a security device since such machine readable components often require adding layer(s) of material to the security device which violates the thickness specifications needed for a suitable security device. BEMs often also struggle with detecting certain security devices such as foils, taped on threads or windowed forms.

Additionally, where a security device is not equipped with a machine readable effect, most BEMs are unable to read/detect the security device. Accordingly, it is then required that the BEMs analysis mask/cover the security device such that it does not interfere with the reading of the machine readable effect by the BEMs. In such instances, a counterfeit security device will not be detected by BEMs. Moreover, if the security device is missing, the BEMs will not be able to detect its absence.

Due at least in part to the above deficiencies, there heretofore remained a need for a security feature that could provide the deterrence provided by conventional security devices but also that will deter or defeat counterfeiters who will rely on harvesting to produce counterfeits.

### SUMMARY

The inventor has surprisingly found that the above objective can be met by providing an inventive security feature which couples a security device and machine detectable indicia. Harvesting the security device will disturb or ruin the machine readable effect (e.g., signal) thereby allowing detection of the harvesting.

Aspects of the present invention will be described herein by reference to particular embodiments. While such embodiments are presented herein as means of helping or enabling a PHOSITA to make and use the invention without having to resort to undue experimentation, such exemplary embodiments are not intended to limit the claimed invention unless so incorporated in the claims.

In certain aspects, the present invention provides (i) a security feature, (ii) a method of manufacturing the security feature, (iii) a security feature made by the method of manufacturing described herein, (iv) use of a security feature as described herein for providing authenticity to a product and for providing evidence of harvesting, and (v) a manufactured product comprising the security feature described herein.

In one embodiment of the security feature, the security feature comprises a substrate; a security device; and machine readable indicia; wherein the security device is integrated with the substrate such that at least a portion of the security device is disposed and exposed over a surface of the substrate; and wherein the machine readable indicia is coupled to the security device such that the indicia extends over at least a portion of the substrate and at least a portion of the security device.

In one embodiment of the method of manufacturing the security feature, the method comprises providing a substrate; integrating a security device with the substrate such that at least a portion of the security device is disposed and exposed over a surface of the substrate; and coupling a machine readable indicia with the security device such that the indicia extends over at least a portion of the substrate and at least a portion of the security device.

In one embodiment of the security feature made by the above method of manufacturing, the security feature includes a substrate, a security device and machine readable indicia wherein the security device, is integrated with the substrate such that at least a portion of the security device is disposed and exposed over a surface of the substrate; wherein the machine readable indicia is coupled to the security device such that the indicia extends over at least a portion of the substrate and at least a portion of the security device; and wherein the security feature is produced by the method of manufacturing a security feature.

In one embodiment of the use of a security feature to provide authenticity to a product the use comprises applying the security feature to a substrate wherein the security feature is a security feature as described herein.

In one embodiment of the manufactured product, the manufactured product comprises a security feature as described herein, where the security feature is as described herein throughout; and wherein the manufactured product is selected from a high security product or a high value product.

Further aspects of the invention include manufactured products such as sheet materials, documents, articles of clothing and various other articles of manufacture having an optical security device, as described herein, being incorporated therewith.

Use of the terms “a” or “an” herein shall be understood as meaning one t r more unless specified.

The invention will now be further described herein such that a PHOSITA may be able to make and use the invention without having to resort to undue experimentation.

### BRIEF DESCRIPTION OF THE DRAWINGS

Particular features of the disclosed invention are illustrated by reference to the accompanying drawings in which:

FIG. 1 is a plan view of an article of manufacture having a security feature and depicting an oscillation zone for which the machine readable indicia must compensate;

FIG. 2 is a plan view of an article of manufacture having a security feature with a security device prior to harvesting; and

FIG. 3 is a plan view of an article of manufacture having a security feature with, a security device after harvesting.

### DETAILED DESCRIPTION

A security feature is provided herein along with a method of manufacturing such a security feature and ways of using said security feature. The inventors have surprisingly found that a machine readability effect can be coupled with a security device to provide anti-counterfeiting protection to high security products or high value products without violating the specifications for what is a suitable thickness of the security device. Moreover, by coupling the machine readability with a security device, would-be counterfeiters can be defeated when they rely on harvesting techniques.

The security feature comprises a substrate on/into which the security device is integrated. Suitable substrates will be apparent to a PHOSITA and shall include, for example, metal, polymer or paper made of cotton, cotton blends, or wood pulp. In one embodiment, the substrate is a paper having at least one flat surface onto which a security device can be affixed.

It is contemplated within the scope of the instant invention that integration of the security device with the substrate may be by any process by which the security, device is affixed to the substrate. Particularly, the security device is affixed to the substrate such that harvesting of the security device or certain portions thereof will ruin the machine readable indicia such that reading of the machine readable indicia shall indicate the harvesting of the security device. Such processes of affixing the security device to a substrate are generally known to a PHOSITA. In one embodiment, the security device is integrated with the substrate by treating the substrate, the security device or both with an adhesive composition. While various adhesives may be employed, and indeed different kinds may be used for the substrate and for the security device, it is preferred that a heat-sensitive, pressure-sensitive, radiation activated, or water activated adhesive is employed. Alternatively, the security device may be integrated into a substrate during the manufacture of the substrate such that the security device is at least partially embedded such as in the case of a windowed substrate where the security device traverses/alternates regions of closed and opened window areas. In the open window areas the security device appears on the surface of the substrate where it is exposed for viewing and can be coupled with other features on the surface of the substrate. In the closed window areas or bridge areas, the security device is obscured as it is buried beneath the fibers forming the substrate. Accordingly, in a particular embodiment, the security device is integrated with the substrate through a windowed integration or by a surface integration. In either case, the security device is integrated with the substrate in a manner which allows for the coupling of the machine readable indicia with the security device.

While the present invention is not limited by, or to, any particular security device form, it is preferable that the security device as integrated is in the form of a patch, stripe, thread or foil. When used in the form of a security strip, thread, patch, or overlay, the total thickness of the security device is preferably less than about 50 microns (more preferably, less than about 45 microns, and most preferably, from about 10 to about 40 microns). Security devices that provide at least one of holographic, micro-optic, micro-text, optical variability or machine readability effects are most preferred. In one embodiment, the security device is a micro-optic security device which comprises an arrangement of focusing elements and an arrangement of image icon elements where the security device provides a synthetic image when at least portions of the arrangement of image icon elements are viewed through at least portions of the arrangement of focusing elements. The inventor has found that coupling of the machine readable indicia with the security device is most advantageous with micro-optic security devices in part because such devices must meet strict thickness specifications in order for the micro-optic effect to maintain its synthetic image resolution while meeting the thickness suitability specifications for incorporation into banknotes so as to avoid adversely affecting the topography of the banknote and stacking of sets of banknotes.

In one embodiment, the micro-optic security device includes hexagonally or octagonally arranged focusing elements that have either a spherical or aspherical base. While such embodiments are preferred, these embodiments are not intended to be limiting of the scope of the invention. Accordingly, the arrangement of the focusing elements may take many other shapes besides hexagonal or octagonal and may also be of various designs. Similarly, the individual focusing elements or sets of focusing elements may take various surface shapes, base shapes, sizes, refractive indexes and the like. In the various embodiments described herein, it is also contemplated that in another further embodiment the security device is a micro-optic security device having the focusing elements or subsets thereof embedded. Suitable means of embedding the focusing elements are described in international patent application publication U.S. Pat. No. 8,867,134, which is hereby incorporated herein by reference in its entirety. Other suitable micro-optic security devices are described in U.S. Pat. Nos. 7,333,268, 8,120,855, 7,468,842, 7,738,175 and 8,773,763, which are hereby incorporated herein by reference in their entirety.

Security devices with effects independent of the machine readable indicia such as those demonstrating optical variability effects, micro-text effects, or holographic effects are also contemplated as suitable for the present invention and shall include those described in patent documents WO2013028534A1, US20140300095A1 WO2013163287, WO2008152389A2, and WO2010046708A1 which are hereby incorporated herein by reference in their entirety.

The arrangement of image icon elements provides an, image element that is viewable through the arrangement of focusing elements. Image icon elements can take various shapes, sizes and designs; each of which may be elected to provide a desired micro-optic effect (i.e., synthetic image). Moreover, the interaction between the arrangement of image icons and the arrangement of focusing elements may be designed to provide certain micro-optic effects (i.e., moiré effects, dynamic image movements, etc.). In a preferred embodiment, the image icon elements of the micro-optic security device are nano-sized, micro-sized or a combination of both. The inventor has found that nano-sized and micro-sized image icon elements work particularly well with coupled machine readable features. This is particularly so where the image icon elements are voids which are filled with a contrasting material such as a pigmented or metallic material. By having micro-sized, or more preferably, nano-sized image icon elements, the contrasting material provides less interference with the machine readable indicia since the contrasting material, in order to fill the voids, must also be nano-sized or micro-sized. Examples of micro-optic security devices formed from a micro-structured approach (i.e., including nano-sized and/or micro-sized image icon elements) are provided in international patent application publication WO2015/034190A1 and in U.S. Pat. Nos. 7,333,268 and 7,468,842. These patents collectively describe a micro-structured approach to forming the icon elements which may be in the form of voids, posts or print formed on or in a layer disposed proximate the base of the focusing elements and distal from their apex. Where the image icon elements are filled or coated with the contrasting material, the contrasting material is cured or otherwise solidified. Alternatively, it is also contemplated that the solid regions between the voids are treated with the contrasting material or that portions of the voids and/or portions of the solid regions are treated with the contrasting material. Similarly, where the image icon elements are posts or print, the image icon elements are applied to a surface proximate the base of the focusing elements. In any of the above cases, the image icon elements are disposed relative to the focusing elements such that at least portions of some of the image icon elements (whether or not filled or coated, partially or fully), are situated at the focal point of at least some of the focusing elements. It is also contemplated herein that for micro-optic security devices, they further comprise one or more additional arrangements of focusing elements, an additional arrangement of image icon elements, an intermediate layer (e.g., optical spacer) between the image icons and focusing elements, or an additional layer disposed above the focusing elements or below the image icon elements.

In the present invention, the coupling of machine readable indicia with the security device provides broad anti-counterfeiting protection to products having such features. The machine readable indicia should be understood as any text, symbol, design, pattern number or combination thereof where the indicia is imbued with at least one detectable characteristic generally not detectable by the human eye. In, one embodiment at least one of the detectable characteristic is characteristic IR, UV, fluorescent, visible, or magnetic signal that is detectable by a machine. BEMs as used herein shall include any machine which can be used to detect a signal being generated by the machine readable indicia. Preferably, such machines include high speed used note sorting machines. BPS X9, BPS M7, BPS B1, BPS C1, Numeron, NotaTracc, NotePack, BPS M5 and BPS C4, all available from Giesecke & Devrient are suitable machines that represent examples of the kind of machines that can be used to detect the characteristic signal or can be easily modified for such purpose. As used herein, a detectable signal is a signal that is characteristic of the indicia material such that it may be reliably measured against a standard. In one embodiment, the machine readable signal has a known graphical read-out against which all measurements of the machine readable indicia are compared for authenticity. For example, an IR based machine readable indicia would be compared against a corresponding IR absorption spectrograph for the particular IR material used in the indicia. Similar UV-based machines are also known to a PHOSITA and are likewise contemplated for corresponding use within the scope of the instant invention. Materials for providing detectable magnetic, IR or UV signal are known to a PHOSITA. Preferably, the magnetic material relies on characteristic coercivity and/or remanence values for the material. Suitable magnetic materials are described in EP0773872B1, Suitable IR materials are known to a PHOSITA and include, for example, those described in international patent application publication WO2007132214 and US patent application publication US20100059691A1, which are hereby incorporated herein by reference for such purposes. Suitable fluorescent materials are known to a PHOSITA and include, for example, those described in international patent application publication WO2008065085, which is hereby incorporated herein by reference for such purposes.

In preferred embodiments the machine readable indicia is provided in ink form and printed onto the substrate where the ink comprises pigments of at least one of fluorescent, visible, IR, UV, magnetic or pearlescent materials. In a certain embodiment, the machine readable indicia, whether or not in ink form, is coupled to the substrate and the security device by being layered directly onto or beneath the security device. Alternatively, it is also contemplated herein that the machine readable indicia is coupled to the substrate and security device such that the indicia is complementary to indicia present in the security device. Accordingly, in one embodiment, partial text in the security device is completed by indicia provided by the machine readable indicia. In another embodiment, the machine readable indicia is indirectly coupled to the security device by being printed onto the substrate in bridge areas overlying an embedded or partially embedded security device. In such embodiments, it is preferred that the indicia is also complementary to indicia in the windowed areas of the security device.

Various materials are contemplated for incorporation into the machine readable indicia such that they provide the signal necessary for machines such as a BEMs machine to read and detect the characteristic signal. In one embodiment, the machine readable indicia includes at least one taggant or pigmented material having a characteristic machine readable signal profile. Inks containing carbon black or magnetic particles are preferred where these inks appear to have identical visual appearance to the human eye to other inks or features on the substrate but provide a distinct machine readable signal. Other preferred materials include pigmented inks such as SICPA Talk® or NeoMag® both available from SICPA SA, Av de Florissant 41, 1008 Prilly, Switzerland. The pigment may be an organometallic pigment such as a metal-containing phthalocyanine pigment which absorbs or reflects more than 75% of any near IR light when viewed in transmission (% T<25% from 750-950 nm), and which is viewable at the following wavelengths: 750 nm; and 900 nm. Suitable materials may be adjusted for particular machines based on pigment size, rheology, viscosity or drying chemistry.

In another such embodiment, the IR-absorbing component is an IR-reactive pigment sold as part of an ink or ink vehicle under the trade designation LUMOGEN-S by BASF Corporation, 100 Park Ave., Florham Park, N.J. 07932. This pigment is invisible in the visible region of the electromagnetic spectrum.

The machine readable indicia is coupled with the security device such that the complexity of the security features are multiplied. Particularly, this adds a covert or semi-covert security effect to the security device without increasing the thickness of the security device. Moreover, by coupling the machine readable indicia to the security device such a resultant feature will defeat would-be counterfeiters who would use harvesting techniques to counterfeit genuine products.

Coupling of the security device with the machine readable indicia results in the indicia being disposed over at least a portion of the substrate and also over at least a portion of the security device. Particularly, the indicia extends over the substrate and the security device in a manner that is identical to any other indicia extending over the substrate and security device such that the machine readable indicia is not readily identifiable solely by the human eye.

In coupling the machine readable indicia with the security device, it is contemplated that either the security device or the print may be applied first or portions thereof may be applied first. For example, in one embodiment, the machine readable indicia are applied to the substrate first then the security device is applied over the indicia or next to the indicia. Where the security device is coupled next to the indicia; it is contemplated that the security device is provided with complementary indicia (a species of machine readable indicia) disposed over the security device or is interleaved between layers or components of the security device. Where the machine readable indicia is applied to the substrate first and the security device is applied over the indicia, it is applied such that harvesting of the security device necessarily perturbs, ruins or otherwise changes the detectable signal. For example, a suitable adhesive, such as a water-activated or heat-activated adhesive is used to dispose the security device over or onto the machine readable indicia. The security device may also be affixed to a surface of a substrate with or without the use of an adhesive. Where the security device is affixed without an adhesive, this may be achieved by, for example, thermal welding techniques such as ultrasonic welding, vibration welding, and laser fusing. Adhesives for adhering the inventive devices to a surface of a document may be one of hot melt adhesives, heat activatable adhesives, water-activated adhesives, pressure sensitive adhesives, and polymeric laminating films. These adhesives are preferably crosslinkable in nature, such as UV cured acrylic or epoxy, with crosslinking achieved while the adhesive is in the melt phase.

In one embodiment, the machine readable indicia is coupled to the security device such that it extends over only a part of the security device thereby providing machine illegible areas of the security device that appear identical to the machine readable indicia portions. Machine illegible areas refer to areas with indicia which lacks a machine readable material.

In one embodiment, the security device comprises a machine readable element integrated within the security device whereby the machine readable indicia provide a signal which is complementary to a signal provided by the machine readable element. Accordingly, where the security device is harvested by replacing it with a counterfeit security device, even if the counterfeit is equipped with a machine readable element, the combined complementary signal from the security device and the machine readable indicia will be detected. In such an embodiment, it is preferred that the security device is in register with the machine readable indicia such that a single pass through the machine will be suitable for detecting the complementary signal. As used herein, the complementary signal is to be understood as a species of machine readable signal.

While it is preferred that the machine readable indicia and the security device are both on the same surface side of the substrate, it is also contemplated that the security machine readable indicia is applied on a first side of the substrate and the security device is applied on an opposing side of the substrate. Here, the machine readable indicia extends over a portion of the substrate and abuts the area of the substrate directly opposite the security device or extends over the area of the substrate directly opposite the security device. In any case, the security device is provided with complementary indicia disposed over the security device, beneath the security device or interleaved between components or interfaces of the security device.

In another embodiment, the machine readable indicia is applied after the security device, or at least one component thereof, is integrated with the substrate. Here the machine readable indicia is disposed over the security device (i.e., the full device or components thereof) such that harvesting of the security device perturbs, ruins or otherwise changes the detectable signal of the machine readable indicia.

Suitable application methods for applying the machine readable indicia will be apparent to PHOSITAs. For example, application may be by various print methods such as intaglio, offset, screen, or letter press; preferably intaglio or offset and more preferably intaglio. Fine lines print features or designs extending over the substrate particularly suited as the machine readable indicia.

In a preferred embodiment, the machine readable indicia is provided over a region of the substrate suitably enabled for machine detection of the characteristic signal. Accordingly, in one embodiment, the machine readable indicia is provided with machine readable resolution. For example, in one particular embodiment, the machine readable indicia covers an area of greater than 1.8 mm, preferably greater than 2 mm. The inventors has surprisingly found that below 1.8 mm it becomes difficult to account for oscillation of security devices provided as threads, strips, stripes or patches; particularly as thread or strips. Accordingly, at 1.8 mm or 2 mm, general oscillation of the thread location will not materially affect the coupling of the machine readable indicia with the security device.

In one embodiment, the security feature is used to provide authentication to a product wherein the security feature is as described herein and is incorporated into a product such that harvesting of the security feature changes the machine readable signal provided by the machine readable indicia.

In one aspect, the invention is an article of manufacture. For example, in one embodiment the invention is a banknote comprising a security feature as described herein, where the security feature authenticates the banknote such that harvesting of the security device is detectable. In another embodiment, the article of manufacture is an identification document or a national security device or component.

The invention will be further described by reference to particular drawings that demonstrate exemplary embodiments of the invention.

FIG. 1 provides a plan view of an article of manufacture (10) having a security feature integrated therein, where the security feature comprises a substrate (11), a security device (12) and a machine readable indicia (13) where the machine readable indicia (13) is coupled to the security device (12) by extending over a surface of the substrate (11) and over a surface of the security device (12). The security device (12) is displayed here with an oscillation zone for which the machine readable indicia (13) must compensate for or cover.

In one embodiment, as presented in FIG. 1, the machine readable indicia (13) is an ink composition comprising a magnetic material which is printed over the security device (12) and the substrate (11). The area over the substrate (11) and that over the security device (12) both provide 2 signals of remanence and coercivity.

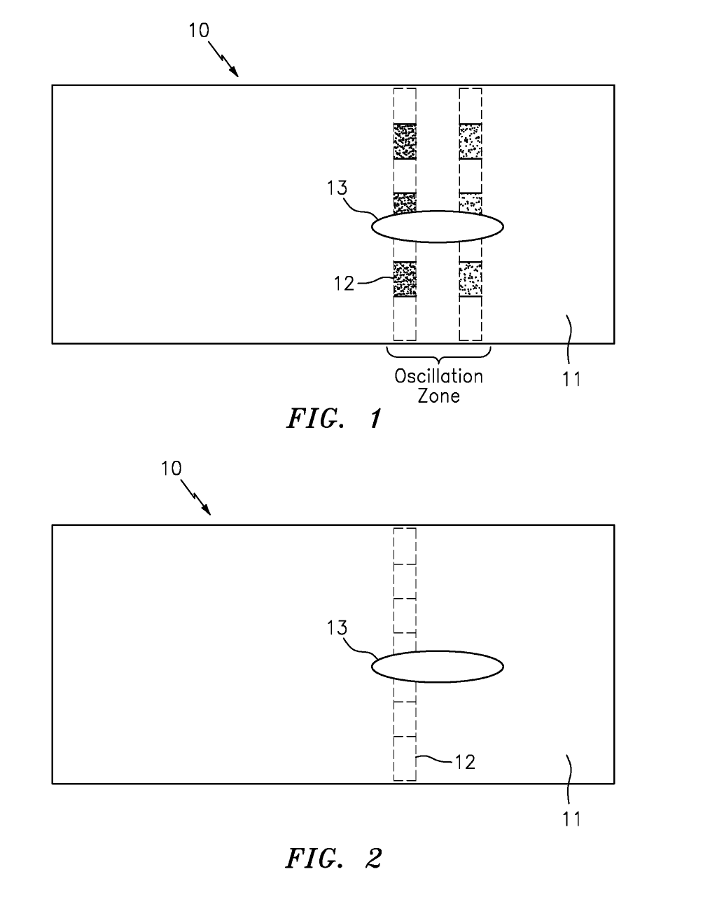

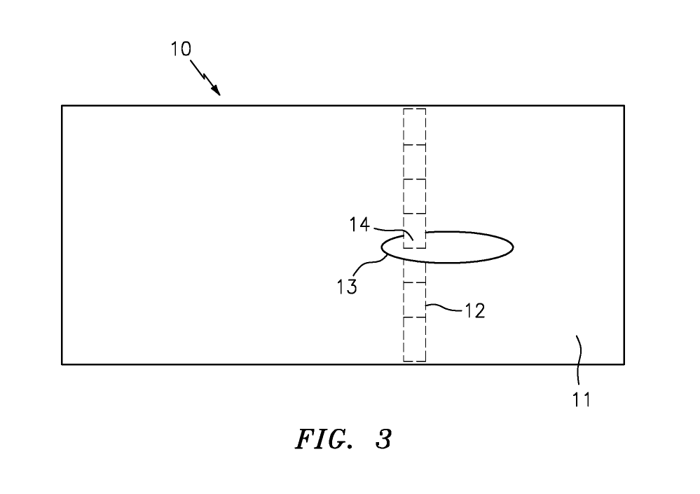

FIG. 2 illustrates the embodiment of the article of manufacture (10) when the security device (12) remains intact and is not harvested. Here a machine capable of detecting the machine readable signal will detect the presence of the correct signal which will indicate the presence of the authentic security device (12). However, where the security device (12) is harvested, the machine will detect an incorrect signal indicating the harvesting of the security device (12) or a defect area (14) in the security device (as shown in FIG. 3). The signal here will be altered by the break in the machine readable indicia (13).

In one embodiment represented by FIG. 2, the machine readable indicia (13) includes SICPA Talk which provides a particular IR spectrograph characteristic of the SICPATalk ink.

While various embodiments of the present invention have been described above it should be understood that they have been presented by way of example only, and not limitation. Thus, the breadth and scope of the present invention should not be limited by any of the exemplary embodiments.

The invention claimed is:

1. A security feature comprising:
a substrate;
a security device; and
machine readable indicia;
wherein the security device is integrated with the substrate such that at least a portion of the security device is disposed and exposed over a surface of the substrate;
wherein the machine readable indicia is coupled to the security device such that the indicia extends over at least a portion of the substrate and at least a portion of the security device.

2. The security feature of claim 1, wherein the substrate is a poly substrate, a paper substrate, or a combination thereof.

3. The security feature of claim 1, wherein the security device provides at least one of a holographic, micro-optic, micro-text, micro-mirror, optical variability or machine readability effect.

4. The security feature of claim 1, wherein the security device is in the form of a patch, stripe, thread, foil or combination thereof.

5. The security feature of claim 1, wherein the machine readable indicia is indicia having a visible, infrared (IR), ultraviolet (UV), or magnetic signature that is detectable.

6. The security feature of claim 1, wherein the machine readable indicia provides at least two detectable signals.

7. The security feature of claim 1, wherein the security device is integrated with the substrate by being a windowed security device or an exposed security device.

8. The security feature of claim 1, wherein at least one of the machine readable indicia is selected from a pattern, text number, symbol, diagram, design or a combination thereof.

9. The security feature of claim 1, wherein at least one of the machine readable indicia is coupled to the security device such that harvesting of the security device removes at least a portion of the machine readable indicia and/or changes the detectable signal of the machine readable indicia.

10. The security feature of claim 1, wherein the machine readable indicia is coupled to the security device by a printing process where at least one of the printing process is selected from intaglio, offset, screen, or letterpress.

11. The security feature of claim 1, wherein the security device comprises an arrangement of focusing elements and an arrangement of image icon elements, wherein the arrangement of focusing elements are disposed relative to the arrangement of image icon elements such that a synthetic image is provided when at least portions of the arrangement of image icon elements are viewed through at least portions of the arrangement of focusing elements.

12. A method of producing a security feature comprising:
providing a substrate;
integrating a security device with the substrate such that at least, a portion of the security device is disposed and exposed over a surface of the substrate; and
coupling a machine readable indicia with the security device such that the indicia extends over at least a portion of the substrate and at least a portion of the security device.

13. The method of claim 12, wherein the step of coupling the machine readable indicia to the security device is by a printing process where at least one of the printing process is selected from intaglio, offset, screen, or letterpress.

14. The method of claim 12, wherein the step of integrating the security device with the substrate includes at least one of integrating the security device as a windowed device and integrating the security device as a surface device.

15. The method of claim 12, wherein the machine readable indicia is formed from a pigmented ink or unpigmented ink having an IR, UV, or magnetic signal that is detectable.

16. A security feature having a substrate, a security device and machine readable indicia,
wherein the security device is integrated with the substrate such that at least a portion of the security device is disposed and exposed over a surface of the substrate,
wherein the machine readable indicia is coupled to the security device such that the indicia extends over at least a portion of the substrate and at least a portion of the security device, and
wherein the feature is produced by the method of claim 2.

17. Use of a security feature to provide authenticity to a product wherein the security feature is applied to a substrate, wherein the security feature is a security feature of claim 1.

18. A manufactured product comprising:
a security feature of claim 1;
wherein the manufactured product is selected from a high security product or a high value product.

19. The manufactured product of claim 18, wherein the highsecurityecurity′product is a banknote, passport, stamp, identification, certificate, or check.

20. A banknote comprising:
a security feature having (i) a substrate, (ii) a security device affixed to a first side of the substrate, and (iii) a machine readable indicia in the form of text, numbers, patterns or symbols applied by at least one printing method selected from intaglio and offset printing to a first side of the substrate,
wherein the machine readable indicia is coupled to the security device by being printed over an area covering both portions of the substrate and portions of the security device,
wherein the machine readable indicia provides a machine readable signal observable in at least one of the IR or UV spectrum and having at least one dimension of at least 2 mm, and
wherein removal a portion of the security device renders changes the machine readable signal such that a harvesting event can be detected.
